(19) United States
(12) Patent Application Publication
(10) Pub. No.: US 2008/0302624 A1
(43) Pub. Date: Dec. 11, 2008

(54) Transmission synchromesh and thrust piece of a transmission synchromesh

(75) Inventors: Janina Steinz, Biebesheim (DE); Klaus Kalmbach, Mossingen (DE); Harald Scheihing, Stuttgart (DE)

Correspondence Address: TRASK BRITT, P.O. BOX 2550, SALT LAKE CITY, UT, 84110, US

(73) Assignee: hofer-pdc GmbH, Stuttgart (DE)

(21) Appl. No.: 12/156,114

(22) Filed: May 28, 2008

(30) Foreign Application Priority Data
May 28, 2007 (DE) 10 2007 025 022.5

(51) Int. Cl. F16D 23/08

(52) U.S. Cl. 192/53.341

(57) ABSTRACT

A transmission synchromesh is provided that includes a pressure element coupled to a synchronizing ring, and one shift sleeve, wherein the pressure element for detent permits an axial position displacement of the shift sleeve relative therewith. A pressure element and a transmission synchromesh method for improved synchronization are also provided.

### PRIORITY CLAIM

This application claims the benefit of the filing date of German priority application DE 10 2007 025 022.5, filed May 28, 2007, for “TRANSMISSION SYNCHROMESH AND THRUST PIECE OF A TRANSMISSION SYNCHROMESH,” the contents of the entirety of which is incorporated herein by this reference.

### TECHNICAL FIELD

The present invention relates to transmission synchromesh, more particularly, to a synchronizing ring synchromesh with an underlying spring or pressure element. The pressure element, i.e., the spring, improves synchronization by performing additional functions. The invention also relates to a novel spring for a synchromesh according to embodiments of the invention.

### BACKGROUND

With respect to the design of a conventional transmission structure, exemplary reference can be made to the technical documentation of Volkswagen AG relating to the six-speed manual transmission 08D. Furthermore, a widely known synchromesh of similar conventional design can be found in the technical book “Vehicle Transmissions” of the authors G. Lechner and H. Naunheimer, ISBN 3-540-57423-9. Both references in their disclosure scope are fully included as basic presentations with respect to the transmission technology and the transmission synchromesh so that the general terms of the transmission synchromesh need not be extensively presented once again.

In addition, fundamental representations with respect to individual aspects of the transmission synchromesh are disclosed in the publications DE 10 2006 044 352.7 and DE 10 2006 051 399.1, unpublished at the time of the application, and in the published patent DE 10 2005 040 400 B3 whose contents are fully included as disclosure scope in the present application.

Conventional components of single cone synchromesh are a gear wheel, a clutch body, one or a plurality of synchronizing rings, a synchronizer, a compression spring, a ball pin, one or a plurality of pressure elements, also called pressure pads, and a shifting or slide sleeve. The gear wheel can be a needle bearing mounted loose gear. The clutch body is frequently equipped with recessed shift toothing and a friction cone on the outside. The synchronizing ring is guided via stop lugs in the synchronizer. These stop lugs are narrower than the slots in the synchronizer so that the synchronizing ring can radially twist by a certain amount which is called transition play. The opposite cone sits on the inside, the connection to the shaft is effected via the bearing in the synchronizer. The locking toothing is positioned outside and attached to the synchronizing ring. The synchronizing ring is the main function carrier of the synchromesh. The synchronizer is equipped with internal coupling teeth which guarantee the positive connection with the shaft. The compression spring ensures the flexibility of the pressure elements. The ball pin is mounted in the detent grooves of the slide sleeve (in neutral position). The pressure element detents in the slide sleeve via compression spring and ball pin. The slide sleeve is equipped with recessed internal shifting teeth (shifting dogs or jaws).

When changing gears, there is initially a rotational speed differential between the shaft and the loose gear to be shifted, resulting in the transmission jump which is to be overcome. The locking synchronization ensures a non-positive rotational speed adaptation between loose gear and shaft, more preferably drive shaft or output shaft, before the establishment of a positive connection. According to conventional designs, the synchronization process may be divided into five phases. The phases are to be characterized as: Phase I (initial synchronizing); Phase II (synchronization); Phase III (unlocking); Phase IV (freely flying phase); and, finally, Phase V (engagement phase).

According to conventional designs, synchronization between two gears, for example a fixed gear and a loose gear, for the power transmission from a drive shaft to an output shaft of a manual shift transmission is generally accomplished via single or multiple cone synchronization of a synchronizing ring, generally with the interconnection of one or several countershafts for most forward and reverse gears, if not for all. With a shift sleeve, such as a slide sleeve, positive power and torque transmission from a fixed gear to a selected loose gear of the transmission is realized after the engagement of the shift sleeve toothing between the teeth of the synchronizing ring toothing and the clutch body toothing, which is also called locking toothing. In a synchronizer, pressure elements, frequently evenly distributed over the circular circumference, are inserted between the outer toothing of the synchronizer so that the pressure element or the pressure elements assist in the initial synchronization. The pressure element, or a plurality of pressure elements, is made to bear against the synchronizing ring for initial synchronization, in this way ensuring that the friction linings are in contact with one another. Here, the pressure element according to conventional designs is frequently constructed of multiple parts. With many pressure elements, it is usual however that they are arranged or mounted longitudinally moveable in order to be able to perform an offsetting or evasive movement in the sliding direction of the shift sleeve.

A conventional design of realizing the engagement of the slide sleeve with a spring-preloaded engagement element, configured as ball-shaped, as part of the multiple-part pressure element, which engages at the bottom of the slide sleeve, can be seen from the figures of the German utility model DE 200 22 345 U1. The spring located under the engagement element can, for example, be guided in a sleeve as is shown in the German Patent DE 102004 036 507 B3 or as described in European Patent family EP 1 624 212 A1. Alternatively, a J-shaped bow, such as depicted in the German Patent DE 196 32 250 C2, can also be utilized for guiding the spring. Further representations of a pressure element with helical spring for pressing an engagement element against the slide sleeve, such as by way of an engagement groove inwardly formed in the slide sleeve, can be taken from the publications DE 195 80 558 C1, DE 199 41 794 A1, KR-A-10 2001 000 3003 and DE 31 25 424 C2.

Two different exemplary embodiments of a spring element (shown by reference numerals 17 and 18) can be taken from DE 101 29 097 A1, also granted as patent under European patent number EP 1 270 975 B1, which embraces the synchronizing rings either as helical tension spring or as bow-shaped spring in order to pull them in the direction of the synchronizer located in-between. The intention here is to utilize the friction coefficient so that relative movement between synchronizer and synchronizing ring in a primary position may be prevented. The spring has been integrated as additional component in the transmission synchromesh in addition to the conventionally known pressure elements. The play of the synchronizing rings is prevented in that the transmission synchromesh includes pressure elements and tension springs.

Shown in the figures of the German Patent DE 100 06 347 C1, representing conventional synchromesh units, a leaf-like spring underlying an engagement element is visible, the design of which combines the representations of DE 200 22 345 U1 with the representations of DE 101 29 097 A1. In this patent, it is declared that a spring minimizes the space that cannot be functionally utilized.

Moving away from the concept of minimizing the space for a pressure element, the publications DE 101 36 906 A1, DE 102 30 177 A1, also published as WO 2004/005739 A1, DE 102 25 269 A1, DE 103 37 588 A1 and DE 102 31 602 A1 show pressure elements. While, publication DE 100 06 347 C1 shows better utilization of a pressure element.

Other conventional designs are presented in patent publications U.S. Pat. No. 5,113,986 and DE 101 36 429 C1.

Patent publications U.S. Pat. No. 5,638,930 A, DE 10 2005 023 248 A1, DE 202 16 782 U1, and EP 0 870 941 A1 show three-dimensionally shaped pressure elements of sheet metal in conventional designs, such as box-shaped or housing-shaped designs, which are to be engaged in a synchronizer in a free-wheeling manner.

Other conventional designs include the idea to displace the detent into the synchromesh, wherein additional components and elements are necessary, can be taken from patent publications FR 2 846 721 A1 and DE 101 36 906 A1.

Another conventional design of a spring-like pressure element is provided in patent publication U.S. Pat. No. 2,160,091, disclosing a double leaf reinforcement of a flat ball receiving plate, which in turn results in a thicker design of the pressure element.

Owing to the relative movement between pressure elements and slide sleeve during the shifting operation, friction influences the function of the pressure elements to a particular degree. Despite the oil film between both parts, friction is highly dependent on the surface quality of the parts and the applied spring force. Especially with conventional designs of annular spring, a phenomenon which occurs as the friction becomes particularly active. On the one hand, the reason for this is the higher friction value, and, on the other hand, that the spring rings have axial play in one direction (away from the slide sleeve) which is required for initial synchronization.

With a possibility of arresting the slide sleeve, the detent is effected via a detent contour provided on a shift finger, in which a spring-loaded pressure element detents. The shift finger is securely connected with the shifting shaft via which the selection and shifting movements are executed. Frequently detent contours are also worked directly into the shifting shaft. According to a further conventional designs, a rocker arm shift with detent contours provided on the rocker arms, and additional locks are known, which are required for this type of shift with only one shifting shaft since the shifting shaft is only in connection with the selected gap with the corresponding rocker arm and a movement of the rocker arms independent of the shifting shaft which has to be avoided.

It is conventionally known to arrange an additional detent for neutral position and detented gear in such conventional shifting devices. According to conventional designs, the neutral position is detented so that the shifting lever in the neutral position is located in the shifting gap for the third and fourth gear.

Of the mechanisms introduced above, conventionally a plurality of parts are integrated in a shifting system so that in most known cases a shifting rail each interacts with an detent in the device and one on the shifting shaft.

### SUMMARY OF THE INVENTION

Desirably, minimizing the space of a pressure element not functionally occupied may improve a transmission synchromesh. In embodiments of the invention, it may be possible to manufacture a pressure element in a material saving manner. By minimizing the space, the remaining synchromesh components of the transmission synchromesh may be designed stronger, thicker or more powerful since they need not give up any additional space required for free movement of space request for the pressure element, i.e., such as the space for the swing-folding-longitudinally or rotationally moveable to allow the pressure element to move properly therewithin. Furthermore, it is desirable to increase the reliability of the transmission synchromesh not only through the configuration of the individual components, but also to guarantee the reliability functionally.

A transmission synchromesh in accordance with embodiments of the invention is configured in such a manner that gear jumping, i.e., spontaneous disengagement of a gear, is desirably avoided. In other embodiments, shifting rail detents are omitted, and the concomitant minimization of the costs of the transmission are obtained. Of further desire, the occurrence of noises should be preferably low and vibrations minimized. In still other embodiments, the improvement of the efficiency of the transmission may be achieved by avoiding unintentional contacts between the friction surfaces. Including, for instance, the known phenomenon of counter-synchronization when disengaging gears. In this respect, it is desirable to increase tolerance train of the constituent parts within a transmission

In accordance with certain embodiments of the invention, a transmission synchromesh is provided that includes a pressure element coupled to a synchronizing ring, and one shift sleeve, wherein the pressure element for detent permits an axial position displacement of the shift sleeve relative therewith and contributes to the increased reliability of a transmission.

A transmission synchromesh method for improved synchronization is also provided.

Further provided is a pressure element. The novel pressure element may assume the function of a conventional transmission pressure element and conventional spring combined into a single or unitary component.

According to embodiments of the invention, a transmission synchromesh unit is to make available various phases. This also includes the ability of synchronizing. Generally, the transmission synchromesh should be possible for the synchromesh unit to synchronize at least one loose gear, frequently one of two loose gears alternately. In addition, a slide-over function should be available in the transmission synchromesh unit. furthermore, the slide-over function describes the local relationship assumed by a shift sleeve or a slide sleeve relative to the shifting and locking toothing before the actual synchronization phase commences. This phase can also be described as free-flying phase. A leaf-like shaped spring can hold a shift sleeve in a detented position. In addition to the detented position the spring provides an initial synchronization region and the slide-over function for the transmission synchromesh. This means the flat longitudinally extended spring which extends along the axis of the underlying shaft, such as a drive shaft or an output shaft, comprises a plurality of functional regions, including the initial synchronization region, the slide-over function, and the engaging position. The multiple integration of different functions in a component of the transmission synchromesh ensures an extremely compact construction. In addition, combining the functions in a component shortens the tolerance chains.

According to still other embodiments of the invention, the detented position is present in the neutral position. The neutral position is the position of the shift sleeve relative to which the shift sleeve is not detented with any of the loose gears. The neutral position is where the shift sleeve is positioned and removed from the one loose gear, such as between the loose gears, preferentially in the middle thereof. A further second detent position is found through the spring in the shifted state when the shift sleeve engages with the coupling toothing of the loose gear. The two detent positions are spaced out. The shift sleeve is thus detented by the spring in various positions. The detents contribute to the reliability of the transmission synchromesh and partly assume the functions of the remote detents.

In still other embodiments of the invention, the spring is a pressure element for synchronization improvement, such as for improving initial synchronization. The expansion of the function is established within the transmission synchromesh between a locking toothing and a coupling toothing of the shift sleeve and a synchronizing ring. Otherwise, the spring inhibits the shift sleeve in the neutral position from an axial displacement for the axial displacement of the shift sleeve, which in other embodiments takes place in a controlled manner. Inhibiting an unintentional, axial displacement in particular, minimizes or prevents a more or less intensive wobbling of the shift sleeve due to vibration, which has a negative effect on the shifting comfort and the frictionless function of the transmission synchromesh. An axial displacement is possible with intended intervention in the transmission synchromesh an outside input, while otherwise, by itself, the shift sleeve is held in its position without external intervention.

According to still further embodiments of the invention, the transmission synchromesh operates according to a cone synchronization principle. It utilizes at least one spring-like flat pressure element which via at least one rim is hinged to a synchronizing ring, or may optionally be hinged via rims of two synchronizing rings of the transmission synchromesh. As a rule, a plurality of pressure elements, generally of the same type, are distributed over the synchronizer. A middle part of the pressure element allows an axial position displacement of a shift sleeve from the locking position through a radial movement, more preferably force-following evasive movement. The pressure element replicates the integrated functions so that little space is functionally meaningless. The pressure element is embodied so that it can perform an evasive movement in its entirety.

In still other embodiments of the invention, the pressure element and the spring are one and the same component. In its primary position the spring may hold the shift sleeve in a detented position. The double integration saves in the number of components required. The transmission synchromesh becomes simpler and thus more cost effective.

In accordance with embodiments of the invention, a locking position is present in a neutral position and a second detent position is present in a shifted detent position of the transmission synchromesh. Thus there are two additional functions in the pressure element.

In another respect, only the spring assumes the function of a pressure element so that no additional components of different shape are present in the transmission synchromesh which assumes pressure element functions. A fact which in turn contributes to simplify the transmission synchromesh.

The pressure element, which may be shaped from spring steel, comprises an initial synchronization region which promotes rotational speed synchronization adaptation between a locking toothing and a coupling toothing of the shift sleeve and at least one of the synchronizing ring. The pressure element can assume a slide-over position in radial direction on a shaft through springy flexibility of the pressure element, wherein the pressure element may perform entirely a spring movement across its width. Aligned with the center axis of the shaft the spring-like pressure element is preloaded in such a manner that the synchronizing rings relative to each other are attracted to the synchronizer in the transmission synchromesh in such a manner that they are mounted free of wobble. The freedom of wobble contributes to the efficiency improvement and avoidance of rattling noises of the transmission.

The shift sleeve may have a detent contour on one inner side which may optionally include the shape of an equal-sided trapezoid. The detent contour may be embodied as detent elevation. The detent between shift sleeve and the pressure element takes place via the detent elevation.

Furthermore, the spring has at least one stop arch facing away from the center axis of the shaft, which carries out the securing of the detent elevation in the neutral position. The embodiment with stop arches can be easily formed in the industrial manufacturing process through shaping methods such as punching, rolling or folding.

According to a further embodiment of the invention, the pressure element may have a stop arch which inhibits the movement from the neutral position in each of the sliding directions of the shift sleeve.

The pressure element is embodied so that in the detented position, such as when in the neutral position, it freely lies in the transmission synchromesh, except for its synchronizing ring bearing and one, or two, shift sleeve detent(s).

The pressure element, in accordance with embodiments of the invention, of the transmission synchromesh looks like a longish, cuboid-shaped flat leaf. Such a shape has at least one lateral end. Optionally, there are two opposing lateral ends which constitute the narrower sides of the rectangularly, optionally squarely, extended pressure element. The pressure element is fanned out in one piece in order to be able to accommodate therein a retaining pin of a synchronizing ring as spring bearing. The pressure element at its two shorter edges has the appearance of a clip. Since a clip is formed from the pressure element, many sheet metal sections of the blank are used in the forming process.

According to an embodiment the transmission synchromesh has at least one annular spring; optionally two annular springs opposing each other. An annular spring rests against the synchronizer. The annular spring has a tension facing away from the synchronizer to the outside. Tension allows the pressure element to be tensioned against the synchronizing ring in order for it to come to bear against the synchronizing ring. According to embodiments of the invention, two springs acting on each other, the tension spring and the pressure element, create the necessary position safeguard. Alternatively, the pressure element could likewise be embodied as springy element and thus be additionally preloaded against the annular springs.

In accordance with embodiments of the invention when manufactured of sheet metal, the pressure element is a one-piece multiply formed component. In the assembly, one saves money and time by the material flow of a plurality of parts. Accordingly, assembly is simplified.

According to further embodiments of the invention, the pressure element, which may likewise be manufactured of sheet metal, is composed of two parts. The pressure element may then be embodied in mirror image. In its installation position, the pressure element has springs spatially offset from each other between which the pressure element can be accommodated in neutral position. Depending on the embodiment, preference for the sake of material saving can be given to the continuous, one-piece or the spring pressure element split in its approximate center.

According to still further embodiments of the invention, the transmission synchromesh may also be constructed about a spring. The spring assumes pressure element-like functions. The pressure element is embodied as spring-like. The spring is inserted in a synchromesh unit, and optionally includes a plurality of springs therein inserted, for example, three or five times. The transmission synchromesh is located under the shift sleeve. The shift sleeve, also designated slide sleeve, constitutes the component of the transmission synchromesh which limits radially to the outside. In such an arrangement the spring of a synchromesh unit may assume an initial synchronization position. The spring comprises a slide-over region. The spring of the shift sleeve offers a shifted detent position. The spring of the shift sleeve offers a neutral position which, locally removed from the shifted locking position, carries out detent of the shift sleeve. The spring may incorporate the material properties of the spring steel. Many different sections of the spring can be functionally utilized.

The lateral ends of the spring, such as the two opposing lateral ends of the spring, may be fanned out in one piece in order to therein accommodate a retaining pin of a synchronizing ring as spring bearing.

Transmission synchromesh as described hereinabove may operate according to the following transmission synchromesh method, particularly where it utilizes a spring-like pressure element which is hinged to at least one synchronizing ring and acts together with a shift sleeve. The phases: neutral position, initial synchronization, synchronization, unlocking, free flying phase, engaging phase and shifting position—may be assumed with such a novel transmission synchromesh through the method according to the invention, wherein seven or more different phases may be passed. In both the neutral position and in the shift position, local fixing of the shift sleeve occurs through the pressure element in the sense of a detent. The shift sleeve is secured in at least two positions. Accordingly, uncontrolled engaging and uncontrolled disengaging of gears is rendered more difficult.

The teaching according to the invention discloses numerous design implementation possibilities of integrating the detent in the actual synchronization of the transmission synchromesh. Local fixing of the shift sleeve is made possible through the detent. Depending on the transmission realization, the shift sleeve is inhibited or locally retained in three positions in its axial movement play. This takes place through an element securely connected with the transmission shaft. Through its being hinged to the synchronizing ring or the synchronizing rings the pressure element creates a fixed point relative to the transmission shaft. The fixed point constitutes a detent point. The detent prevents the shift sleeve from the free axial mobility. According to at least one embodiment of the invention, the detent establishes a connection between shift sleeve and an element of the transmission synchromesh which is securely connected with the transmission shaft in the manner that the slide sleeve is prevented from axial movement unless an external force is deliberately applied. Thus, the axial fixing of the shift sleeve is relocated to the transmission synchromesh. The transmission synchromesh is improved in certain embodiments of the invention by the absence of external detents and engaging elements such as an arresting device conventionally known. The transmission synchromesh is constructed so that the pressure element may hold the shift sleeve by itself. The detent is only released under the effect of external force. The pressure element holds the shift sleeve. The shift sleeve is multiply held by the pressure element in different positions of the pressure element. The pressure element clamps the two synchronizing rings to each other. Gear jumping is prevented, or minimized, through the pressure element and through the mutual clamping of the synchronizing rings. The pressure element is advantageously embodied in one piece. The detent may only be released from outside the transmission synchromesh. According to a further aspect the invention is characterized by the realization of the detent through a transmission synchromesh-internal spring force, more preferably a pressure element-inherent spring force.

Functionally the transmission synchromesh according to the invention may be understood particularly well in the following five functions: Function I, in the neutral position; Function ii, in the initial synchronization position; Function iii, in the slide-over position; Function iv (a), in the shifted detented position 1; Function iv (b), in the shifted detented position 2; and, parallel to this or permanently, Function v, which attracts the synchronizing rings. Detent in the neutral position creates an axial retention of the shift sleeve (Function i). By means of pressure element, more preferably an area of the pressure element especially provided for this, an inhibition of a movement of the slide sleeve relative to a shaft-fixed part of the transmission synchromesh is achieved. The movement is made possible through or after an effect of an external force. The inherent spring force of the pressure element is overcome through the effect of an external force. The pressure element generates a spring force which originates from within itself, i.e., an inherent spring force. Thus, a simultaneous movement of slide sleeve and pressure element is made possible. The pressure element offers a stop such as a stop arch or a stop surface to the synchronizing ring. The stop or the stop arch guarantees a movement of the synchronizing ring similar to the shift sleeve and to the pressure element (Function ii). With a further axial movement of the shift sleeve, the detent is overcome through an evasive movement of a part of the pressure element in radial direction (Function iii). Once the slide-over position has been left, the pressure element veers in its wave-like region. The spring relaxes. The pressure element offers a further detent trough which is available to the shift sleeve. The shift sleeve is again detented (Function iv). During the Functions i and iv the synchronizing rings are pulled towards each other (Function v).

The transmission synchromesh unit shown corresponds in some parts previously known transmission synchromesh units. Thus, the experiences accumulated during a single and multiple synchromesh can be transferred to a transmission synchromesh according to the invention with improved pressure element. The testing effort of a transmission synchromesh according to the invention is kept within manageable limits.

### BRIEF DESCRIPTION OF THE SEVERAL VIEWS OF THE DRAWINGS

The invention can also be easier understood if reference is made to the enclosed figures, wherein the figures show:

FIG. 1 substantial components of a transmission synchromesh unit according to a cone synchronization principle;

FIG. 2 a section in detail view through a transmission synchromesh unit according to FIG. 1;

FIG. 3 a first exemplary embodiment of a pressure element according to the invention in lateral view;

FIG. 4 the spring-like pressure element according to FIG. 3 in three-dimensional view;

FIG. 5 various positions of the pressure element according to FIGS. 3 and 4 together with a slide sleeve in schematic representation;

FIG. 6 an alternative embodiment to FIG. 3;

FIG. 7 a further exemplary embodiment of a spring-like pressure element;

FIG. 8 the pressure element from FIG. 7 in various selected positions;

FIG. 9 a further exemplary embodiment of a spring-like pressure element in various positions;

FIG. 10 the pressure element from FIG. 9 alone without additional components in schematic representation;

FIG. 11 a further exemplary embodiment of a spring-like pressure element;

FIG. 12 the pressure element from FIG. 11 in various positions together with a shift sleeve;

FIG. 13 an alternative embodiment of a pressure element according to FIG. 7;

FIG. 14 an alternative embodiment of a pressure element according to FIG. 10;

FIG. 15 an alternative embodiment of a pressure element according to FIG. 11;

FIG. 16 an alternative embodiment of a pressure element that was simplified through retaining substantial functional regions; and

FIG. 17 the embodiment according to FIG. 16 in three-dimensional representation.

### DETAILED DESCRIPTION OF THE INVENTION

In the following, the same or similar reference symbols have been selected for similar or same parts between the different embodiments and developments, wherein partly reference numbers numbered higher by 100 in each case have been selected for the various embodiments of similar parts of a pressure element in spring-like embodiment according to the invention.

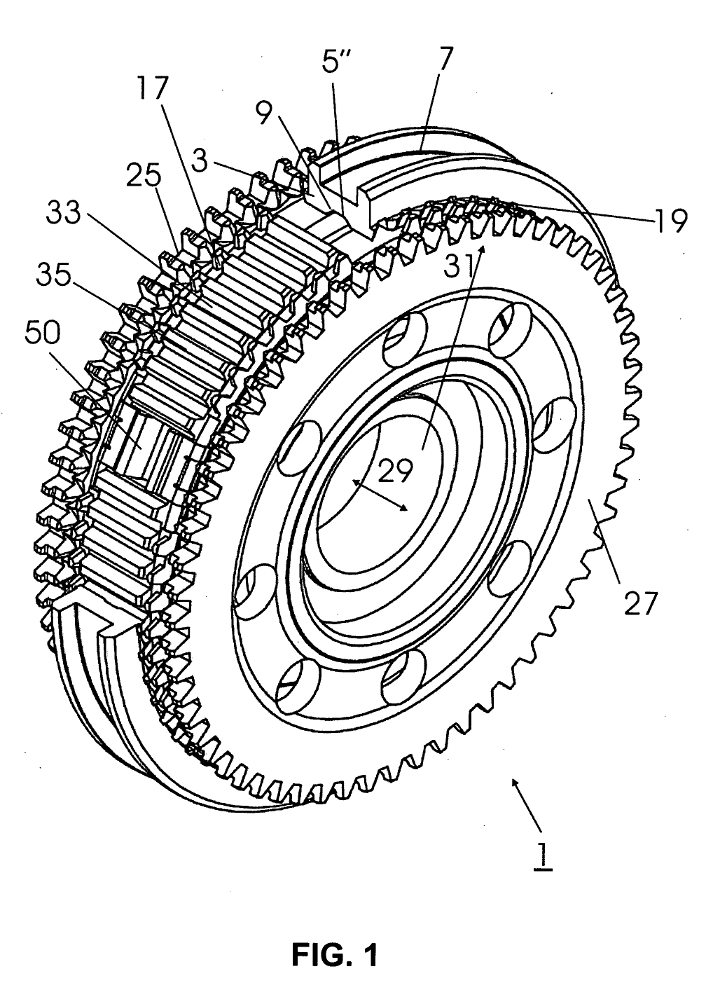

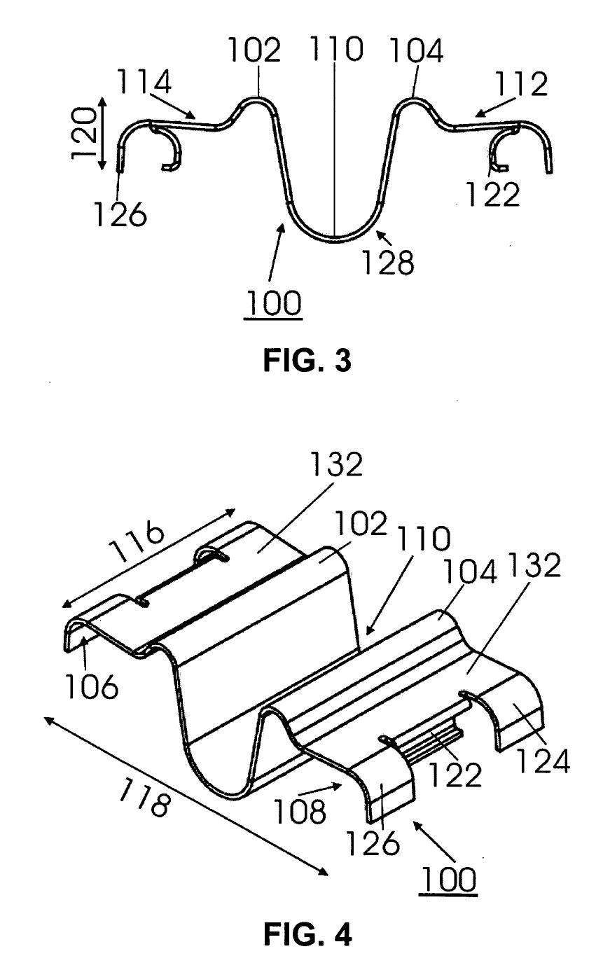

FIG. 1 shows important components of a transmission synchromesh unit 1, wherein for simplification further components such as for instance the two loose gears 11, 13 and a central shaft have been omitted. The round transmission synchromesh unit 1 is limited to the outside by a shift sleeve 3 which in the example shown is a slide sleeve. The shift sleeve 3, which extends over 360 degrees of an angular dimension, is shown cut over approximately 90 degree of its length so that below the shift sleeve 3 a synchronizer 33 is visible on whose surface a synchronizer external toothing 35 is provided which may detent in the shift sleeve 3 in order to ensure a directional guidance in the direction of the axis 29 of the transmission synchromesh unit 1. On the outer side of the shift sleeve 3 a surrounding annular groove 7 may be provided according to an exemplary embodiment in which a shifting linkage which is not shown may detent with a detent rail detent which is likewise not shown. The synchronizer outer toothing 35 of the synchronizer 33 must be provided interrupted in circumferential direction at least once, frequently a plurality of times, in order to accommodate pressure elements or springs 50 between the individual sections of the synchronizer outer toothing 35. The shape of the pressure elements which in the FIGS. 3 and 4 are designated with the reference number 100 and in the FIG. 7 with the reference number 200, or of the springs 50 is embodied so that a mutual detent between pressure element and shift sleeve is possible, as shown for instance via a shift sleeve sliding groove 5″, which may come to bear against at least one shift sleeve sliding edge 9 or several corresponding shift sleeve sliding edges. In the respective axial directions, laterally next to the synchronizer 33, a synchronizing ring 17, 19 is provided which together with a clutch body 25, 27 is able to mutually break and align itself to ensure the synchronization effect of the transmission synchromesh unit 1. The transmission synchromesh unit 1 shows the gears of a clutch toothing and a locking toothing in the region of the outer limit of the radial direction 31 of the synchromesh rings 17, 19 and the clutch body 25, 27. Thus, the springs 50 are likewise positioned in the outer region of the radial direction 31. With regard to the synchronizer 33, the springs 50 are formed so that they protrude only a few percent with regard to the radial direction 31 of the synchronizer 33. The protruding elevation of the springs 50 is limited by the inner or lower side of the shift sleeve 3. A section of the spring 50 and a section of the inner side of the shift sleeve 3 may rest against each other depending on the shift sleeve position. Clutch bodies 25, 27, synchronizing rings 17, 19 and synchronizer 33 are substantially balanced as rotation body in terms of weight, the springs 50 contribute to the unbalance creation only to a minimal degree.

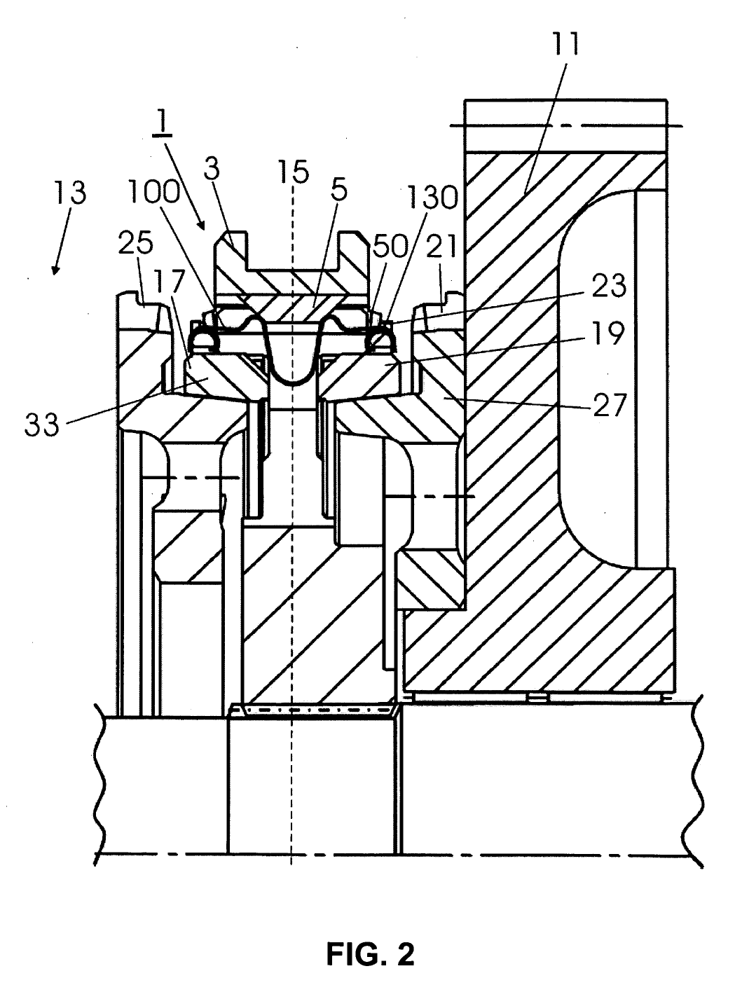

FIG. 2 shows a detail in sectional representation of a transmission synchromesh unit 1 of FIG. 1 which is shown as cone synchromesh in the form of a single cone synchromesh with a first pressure element 100, which is arranged in a recess of the synchronizer 33 provided for the pressure element 100, more preferably in circumferential direction of the synchronizer 33. Frequently a plurality of recesses are provided, each equipped with a pressure element 100. The pressure element 100 is spring-like. Through the spring 50, which represents the pressure element 100, the shift sleeve detent elevation 5 of the shift sleeve 3 may be detented more preferably at a middle distance—a position in the middle 15 of the loose gears 11, 13. The second loose gear 13 is only hinted in its position. The first loose gear 11 is drawn in half. The spring 50 is hinged to the synchronizing rings 15, 17 via its clip straps 130, which are arranged on the left and right of the center 15 of the loose gears 11, 13. The spring 50 thus prevents the wobbling of the synchronizing rings 15, 17. Depending on the detented position, the synchronizing rings 15, 17 rest on a cone seat on the clutch bodies 25, 27. The pressure element 100 serves for the initial synchronizing and synchronizing during a displacement of the shift sleeve 3 in the face of the initial synchronization, through which the locking position is reached. Clutch toothing 21 and locking toothing 23 are brought into agreement with this kind of synchronization so that sliding over along the axis 29 (FIG. 1) of the slide sleeve 3 is possible. The pressure element 100, as may be seen in lateral view, is a light, small multiply bent sheet metal part which in its extreme regions or extremities rests on the bearing points and, in between, is carried free to swing in a freely floating manner in order to be partially upset and stretched through the external effect of force.

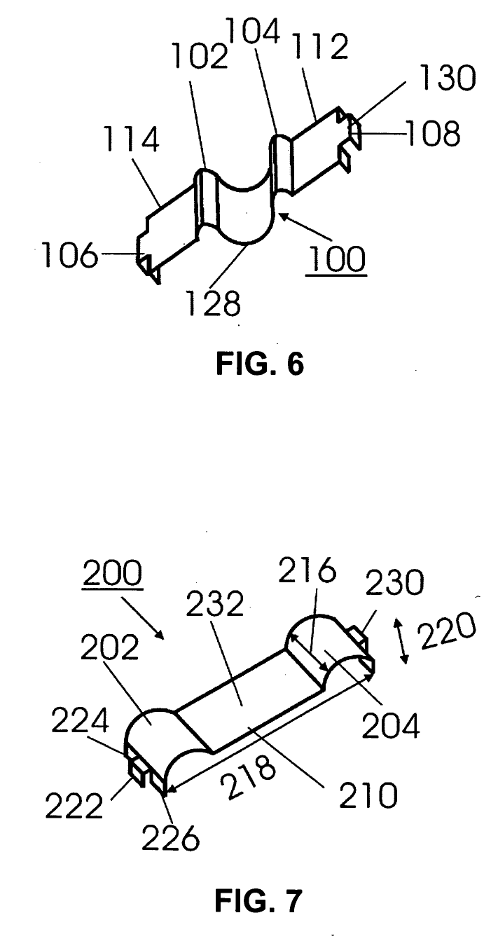

FIGS. 3, 4 and 5 show a first particularly suitable exemplary embodiment of a pressure element 100 according to the invention, wherein FIG. 6 shows a further version 100′ of a pressure element 100, which among other things differs from the representations of FIGS. 3 and 4 through its suspension with clips 130. The spring-like pressure element 100 has been formed in one piece from a flat spring steel through forming of individual sections of the spring element which because of its width 116 and its length 118 is oblong, substantially rectangular, according to an embodiment also square. The spring element after the manufacture substantially maintains its flat shape with a low height 120 compared to the length 118 and to the width 116, so that the spring-like pressure element 100 may be seen as silhouette of a flat, oblong central plane 132 which in its middle region 110 is broken through by a swivel arch 128 facing to the lower side of the pressure element. The swivel arch 128 terminates in a first stop arch 102 and a second stop arch 104. The stop arches 102, 104 protrude from the central plane 132 in the order of magnitude of the height of the clips 106, 108 in opposite direction to the clips 106, 108. The stop arches, 102, 104 together with the swivel arch 128 have a wavy front appearance when viewed from the side as shown in FIG. 3. The respective stop arch 102, 104 merges into a flat run-out region 112, 114 which is followed by the clip strap, divided into 3 clip straps 122, 124, 126. Next to the one run-out region 114 the first clip 106 follows, while next to the second run-out region 112 the second clip 108 is affiliated. The clip 106 or 108 comprises several clip straps 122, 124, 126. The clip straps 122, 124, 126 are designed so that mounting or holding fingers of a respective synchronizing ring may enter as shown in FIG. 2 so that the pressure element 100 via the spring straps 122, 124, 126 form a bearing with the holding fingers of the synchronizing rings. Other than that, the pressure element 100 is self-supporting and freely floating. The swivel arch 128, which is larger than the two stop arches 102 and 104, constitutes the longitudinally moveable offsetting element for movements which run mainly along the length 118 of the pressure element 110. Through the wave-shaped deflection from the central plane 132 of the stop arches 102, 104 and the swivel arch 128 the pressure element 100 during horizontal movements along the axis 29 of the transmission synchromesh unit 1 of the shift sleeve 3 is subjected to only minor twists with respect to its width 116. The largest clip strap 122 is folded multiple times. The two shorter clip straps 124, 126 are simply bent over to the lower side of the pressure element 100. The folding technique of the clips 106, 108 from a plurality of clip straps 122, 124, 126 allows a flat spring steel as source material, wherein as a result secure bearing of the pressure element 100 between the synchronizer outer toothing 35 of the synchronizer 33 may be guaranteed.

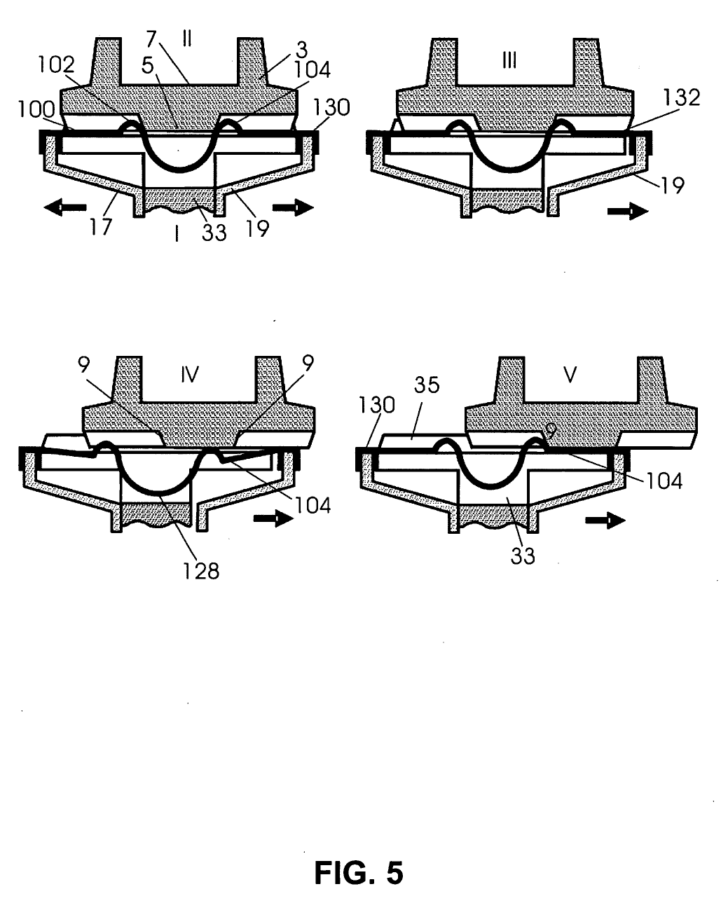

FIG. 5 shows various positions of the shift sleeve 3 which, in horizontal direction, which means along the direction of the axis of the synchronizer 33, may be slid over, i.e., across, the pressure element 100. The sliding force may be directed into the shift sleeve 3 via the annular groove 7 and acts via the shift sleeve detent elevation 5 on contact via, for instance, the shift sleeve sliding edges 9, on individual sections of the pressure element, i.e., the stop arches 102, 104. The pressure element 100 is fastened to the synchronizing rings 17, 19 via the clip strap 130 bent downwards which is positioned vertically. In a first locking position I the pressure element 3 lies in a neutral position II. This position may generally also be called primary position. With the neutral position of the shift sleeve 3, none of the two gears is in the detented state. If now one of the two gears, e.g., the gear via the right loose gear is to be detented, the spring-like pressure element 100 is upset towards the one side through slight lateral displacement of the shift sleeve 3, in this case to the right, while the other side of the pressure element 100 is stretched. The swivel arch 128 serves as longitudinally moveable offsetting element. When the shift sleeve sliding edge 9 of the shift sleeve detent elevation 5 comes to bear against one of the stop arches 102, 104 the shift sleeve 3 has assumed the initial synchronization position or the initial synchronization region. Locking toothing and shift sleeve toothing move towards each other. Subject to further expenditure of force in the sliding direction the shift sleeve 3 rides over the stop arch 104 in the one direction of the stop arch 102 if the second opposite gear formed by the mirror-image loose gear is to be detented. The pressure element 100 in the slide-over position IV may perform an evasive movement in the direction of the underlying central axis, the axial center. The stop arch 102, 104, which is pushed away downwards by the detent elevation 5 of the shift sleeve 3 in the slide-over position IV lies nearer to the center of the axis than the stop arch 104, 102 (in respective axial directions, respectively), that has not been ridden over. Once the shift sleeve 3 reaches the shifted locking position V, the ridden-over stop arch 104 lies in a swung-back position comparable with the original neutral position. The stop arch 104 then constitutes a detent for the shift sleeve sliding edge 9 which lies nearest to the stop arch 104. In the shifted locking position V, gears of the synchronizer outer toothing 35 of the synchronizer 33 are sectionally clear of the shift sleeve 3 or the teeth facing towards the inside. The swing movements take place about a central plane 132.

The pressure element 100′, shown in FIG. 6 differs from the previously shown pressure element 100 through the clip 130. The clip 130 is likewise a fanned-out clip. The middle section of the clip 130 is further removed from the stop arches 102, 104 than the two outer, smaller sections of the clip 130. Otherwise the pressure element 100′ is constructed from one side to the other as follows. A first clip 106 is followed by a run-out region 114 which is followed by the stop arch 102 over the entire width. In addition to the first stop arch 102 there is a second stop arch 104 which in its radius and its size corresponds to the first stop arch 102. The swivel arch 128 to this end has a clearly larger radius. The swivel arch 128 forms the mirror-image axis for the left and the right part of the pressure element 100′. The second stop arch 104 leads into the second run-out region 112 the end of which is limited by the second clip 108.

The spring shown in FIG. 7, the pressure element 200, has a similar clip 230 as previously described in FIG. 6, namely consisting of the middle clip strap 222 which is the widest clip strap and the two clip straps 224 and 226 provided on the two edges, which are arranged counter-shaped to the middle clip strap 222 and spaced in longitudinal direction. The length 218 of the pressure element 200 is thus substantially determined by the distance of the middle clip strap 224 to the opposite middle clip strap. The determination of the width 216 of the pressure element 200 arises from the three clip straps 222, 224, 226. A middle central plane 232, which goes beyond the middle region 210, is limited by the first stop arch 202 and the second stop arch 204. The determination of the height 220 of the pressure element 200 more preferably arises from the height of the stop arches 202, 204 beyond the central plane 232.

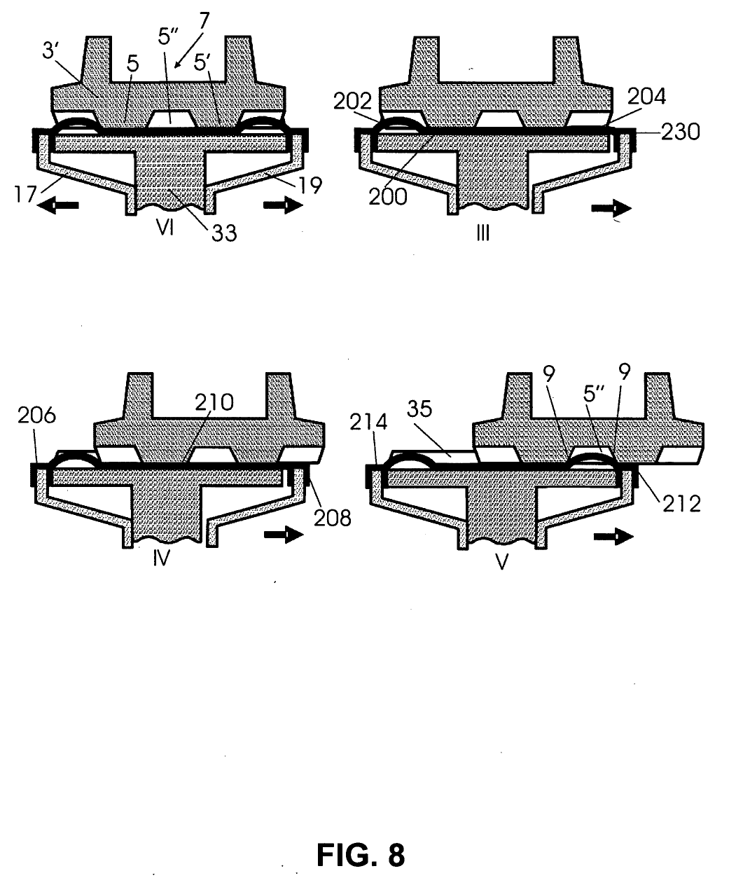

FIG. 8 shows in schematic representation the use of a pressure element 200 of FIG. 7 silhouette-like under a slide sleeve 3′. The slide sleeve 3′ differs from the previously shown shift sleeve 3 through two shift sleeve detent elevations 5, 5′ arranged in longitudinal direction. Between the two shift sleeve detent elevations 5, 5′ there is a shift sleeve sliding groove 5″. The shift sleeve sliding groove 5″ lies on the opposite side viewed from the annular groove 7 of the slide sleeve 3′. The pressure element 200 detents into the two synchronizing rings 17, 19 via the two clips 206, 208. In a middle position of the slide sleeve 3′, when the shift sleeve detent elevation 5, 5′ are arranged above the middle region 210, the slide sleeve 3′ is held in the primary position VI through the stop arches 202, 204. In this case the shift sleeve sliding groove 5″ lies approximately in the middle above the synchronizer 33. The stop arches 202, 204 are followed by the run-out regions 212 and 214, which in turn are followed by the clips 230 for the synchronizing rings 17, 19. The clips 230 on the synchronizing rings 17, 19 offer the bearings for the pressure element 200. They are thus considered as the fixed locations of the spring which forms the pressure element 200. The stop arches 202, 204 may be indented depending on the sliding direction of the slide sleeve 3′ so that as part of an initial synchronization position III the slide sleeve 3′ may start slipping to a side of the synchromesh unit. The stop arch 204 is pushed over by the slide sleeve, more preferably by the shift sleeve sliding edge 9. Upon further sliding of the slide sleeve 3′ the slide-over position IV is assumed which among other things is characterized in that one of the stop arches 202, 204 is completely pressed down so that the slide sleeve 3′ with its inner toothing may be moved in the opposite teeth of the synchronizer outer toothing 35 in longitudinal guidance along the radial axis. Once the gear has been detented, in the shifted locking position IV, the pushed over stop arch 204 buckles again in the shift sleeve sliding groove 5″ and is laterally limited by the shift sleeve sliding edge 9. In the shifted locking position, which holds itself up to a certain expenditure of force and is thus not displaceable, one of the shift sleeve detent elevations 5, 5′ rests above a run-out region 212, 214.

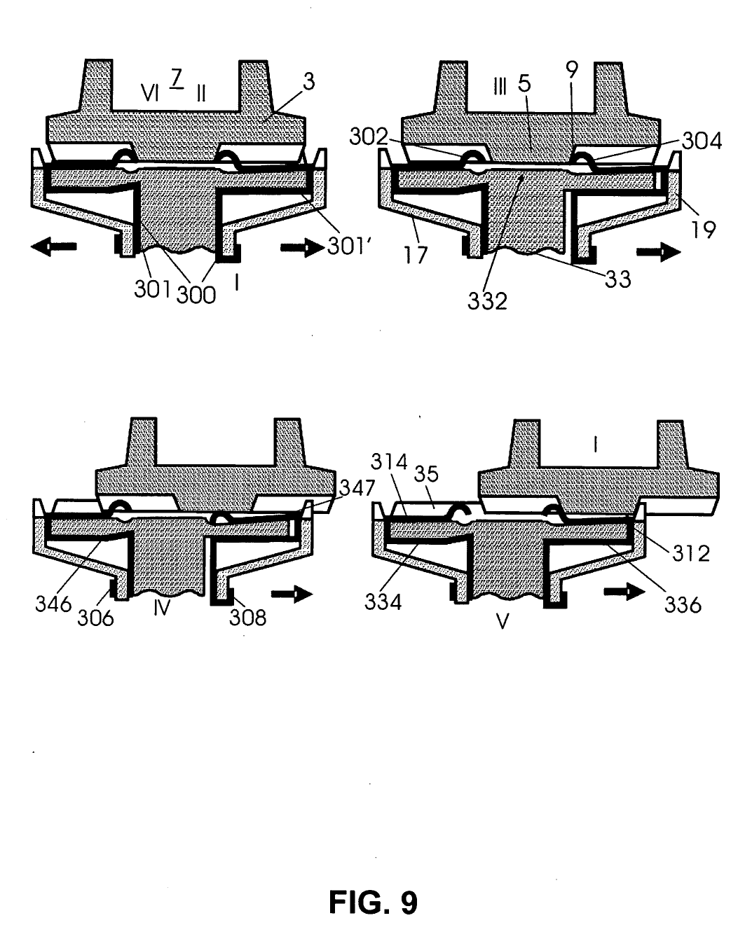

A further embodiment of a spring according to the invention which takes over a pressure element function as pressure element 300 is shown in the shifting positions locking position I, neutral position II, primary position VI, initial synchronization position III, slide-over position IV and shifted locking position V in FIG. 9. The pressure element 300, which in contrast with the pressure elements 100 and 200 is composed of two part pressure elements 301, 301′ in this way forming a pressure element 300, likewise has two stop arches 302, 304, as in the previously described exemplary embodiments of the FIGS. 3, 4, 6, and 7, which, via the shift sleeve sliding edges 9, may hold the shift sleeve 3 in one of the locking positions, either the neutral position II or the shifted locking position V. To this end the shift sleeve 3 has a shift sleeve detent elevation V which lies on the inside, the side facing away from the annular groove 7 of the shift sleeve 3. The spring parts 301, 301′ are hinged to the synchronizing rings 17, 19 of the transmission synchromesh unit via suitable clips 306, 308. Between the spring parts 301, 301′ of the pressure element 300 is located the synchronizer 33 which, with respect to the edge, is limited by the run-out regions 312, 314. The central plane 332, over which the upper side of the pressure element 300 is substantially extended, is an interrupted plane—the middle region intended for the detent elevation in the neutral position III of the detent elevation 3 is recessed from the central plane 332. Below the run-out regions 312, 314, return arms 334, 336 of the spring parts 300, 301 are embodied. The pressure element 300 looks like a shaped T-piece with clip ends on the lower part and raised stop arches on the upper part, approximately towards the middle. In the representation of FIG. 9 two different embodiments of the split pressure element 300 are shown. The spring part 301 is designed with different bevels than the spring part 301′. To promote the functional safety the respective spring part 301, 301′ of the pressure element 300 fits snugly against the synchronizer 33. The synchronizer 33 thus offers additional bevels which serves for the clamping security of the respective spring part 301, 301′. The spring part 301 has a bevel surface 346 which is arranged before the angled-off portion of the pressure element 300. The angled-off portion encloses the trunk of the synchronizer 33. Alternatively the pressure element 300 may be provided with a bevel surface 347 which runs out towards the extremities of the pressure element 300. The bevel surface 347 widens the synchronizer 33 in the outer region of the synchronizer 33. A pressure element 300 may be equipped with a bevel surface 346 on each spring part 301, 301′ as well as with a bevel surface 346 on each spring part 301, 301′ as well as with a bevel surface 347 each. Just the same, an alternating bevel surface usage 346, 347 as shown in FIG. 9 may be selected. The respective stop arch 302, 304 limits the freedom of movement of the shift sleeve 3 in the horizontal plane through a spring-like preloading against the sliding edge 9. The synchronizer outer toothing 35 serves for the longitudinal displaceability of the shift sleeve 3. In the neutral position II which constitutes a detent position I, and is also to be called primary position VI, the two stop arches 302, 304 hold the detent elevation 5 of the shift sleeve 3 in a middle region. The respective stop point 302, 304 may be pressed together in radial direction in the initial synchronization position III. The following short transition arch to the run-out region 312, 314, allows the lowering of the run-out region 312, 314 of the spring 301, 301′. Once the locking toothing and the synchronization toothing, not shown in any detail in FIG. 9, have oriented themselves favorably relative to each other and thus allow the sliding over of the shift sleeve, the slide-over position IV may be assumed through further pressing down of the stop arch 302, 304. Once the sliding over has been completed the stop arch swings outwards again. The stop arch 302, 304 lifts the shift sleeve 3 in the shifted detent position V above a contact along the shift sleeve sliding edge 9.

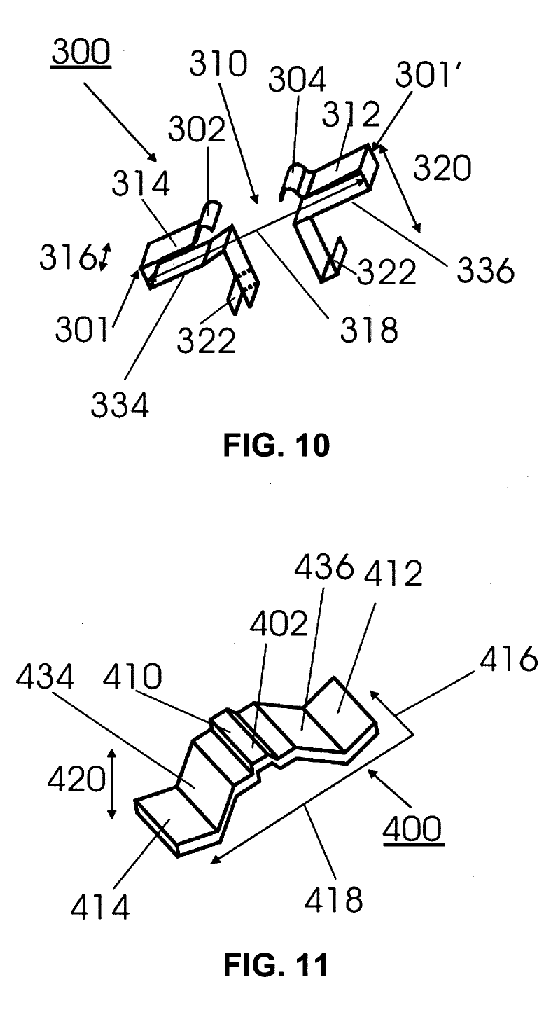

FIG. 10 shows outline-like the pressure element 300 of FIG. 9 described in use, which is composed of the two spring parts 301, 301′. The middle region 310 of this pressure element is recessed. The middle region 310 is followed by the stop arches 302, 304. To the side of a stop arch 302, 304 the run-out region 312, 314 is provided so that the length 318 of the pressure element 300 is determined by the middle region 310, the added diameter of the stop arches 302, 304 and the length of the run-out regions 312, 314. The stop arches 302, 304 have the same width as the width of the run-out region 312, 314 and thus constitute the width 316 of the pressure element 300. Parallel to the run-out region 312, 314 there is a return arm 334, 336 which, spaced from the run-out region 312, 314, with its sheet metal thickness is present via a return piece. The height 320 of the pressure element 300 is thus substantially obtained from the height of the stop arches 302 or 304, the spacing of the run-out region 312 or 314 to the return arm 334 or 336 and the distance to the clip straps 322. To exactly determine the height the sheet metal thicknesses must likewise be mentioned. In an alternative embodiment the fastening arm for the clips 322 may protrude over the exact position of the clip strap 322 in the direction towards the middle of the synchronizer. As shown, one of the two clip straps 322 may be bent upwards while the second clip strap of the second spring part is bent over horizontally.

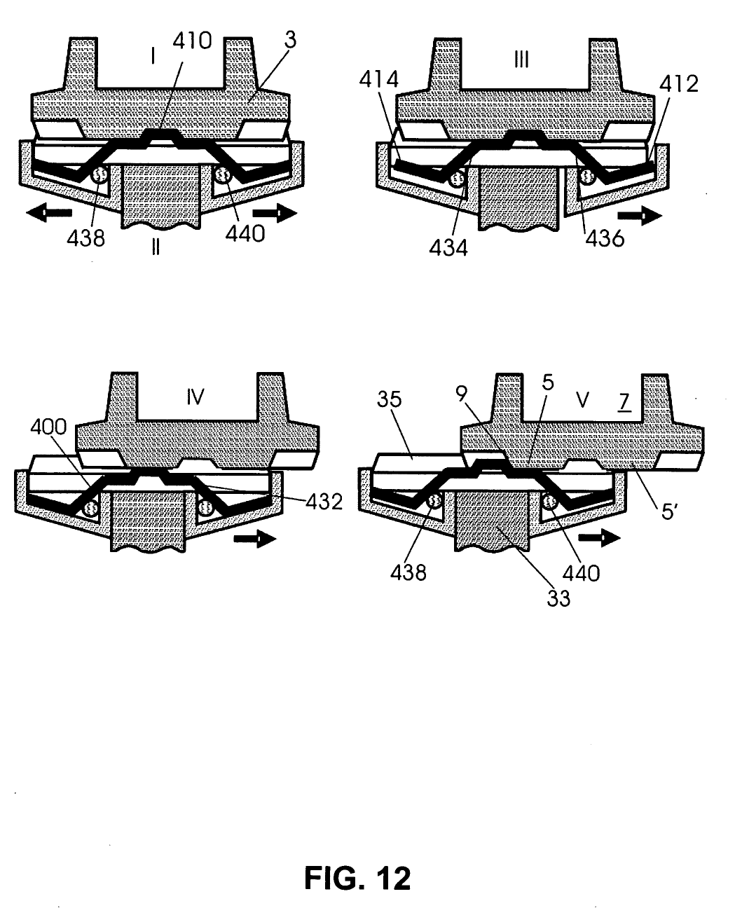

A further exemplary embodiment of a pressure element 400 according to the invention is schematically shown in FIG. 11 whose usage of a transmission synchromesh of the shifting positions selected, namely neutral position II and locking position I, initial synchronization position III, slide-over position IV and shifted detent position V may be taken from FIG. 12. The pressure element 400 likewise looks like an oblong, flat pressure element from which the middle region 410 with its sole stop arch 402 stands out towards the top. The height 420 is smaller than the width 416 or the length 418 of the pressure element 400. Rising bevels 434, 436 follow the stop arch 402 on both sides which in turn are followed by the running-out regions 412, 414. The transitions of the individual regions are angled off. Thus the directions or the orientations of the run-out regions 412, 414 to the rising bevels 434, 436 are angled off. The middle region 410 runs parallel to the central plane as shown in FIG. 12 in lateral view of the pressure element 400. The annular springs 438, 440 via the rising bevels 434, 436 press the pressure element 400 outward into the possible sliding directions of the shift sleeve 3. In the neutral position, the stop arch 410 blocks the shift sleeve 3 from a longitudinal displacement. The entire pressure element 400 may be displaced in horizontal direction via the shift sleeve 3, when directed into the slide-over position III in a longitudinal direction in that the one rising bevel 436 is upset together with the run-out region 412, while the other rising region 434 is stretched together with the run-out region 414. The sheet metal for the spring-like pressure element 400 in the embodiment described here must thus permit such longitudinal changes owing to its bending and forming. The fundamental function sequence however is also guaranteed if the actual pressure element is not embodied as springy element and the springy function is merely taken over by the annular springs. Upon further displacement of the shift sleeve 3 the pressure element 400 is displaced towards the axis of the synchronizer 33. The slide-over position IV grants the shift sleeve 3 an adequate clear run for longitudinal displacement until the shifted locking position V is assumed and the pressure element 400 in its primary position swings up again. The pressure element 400 retains the radial tension through the annular springs 438, 440; the shift sleeve 3 undergoes longitudinal positioning and detent of the shift sleeve 3 via the detent elevations 5, 5′ and the shift sleeve sliding edges 9. The detent elevations 5, 5′ lie on the opposite side of the annular groove 7. The synchronizer outer toothing 35 constitutes the longitudinally moveable guide rail for the shift sleeve 3.

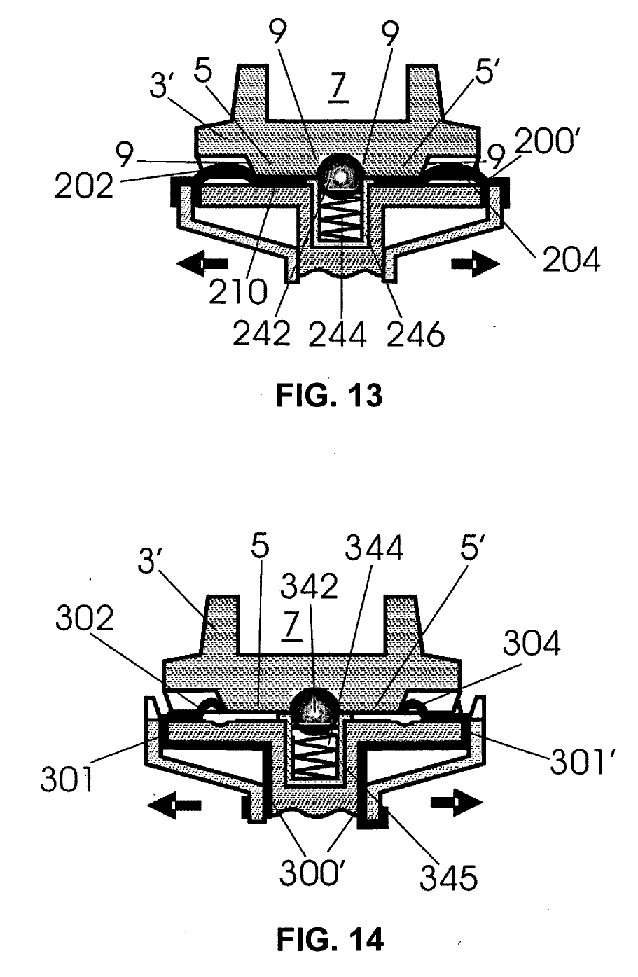

Should it be helpful for whatever considerations such as because of the desired shifting force to be applied, e.g., for the commercial vehicle sector, to provide a further detent the pressure elements 200, 300, 400 shown before may be embodied with a ball pin 242, 342, 442 and a corresponding ball pin spring 244, 344, 444, which is guided in a spring guide 246, 345, 446 as is shown in FIGS. 13 to 15. FIG. 13 shows the pressure element 200′ with its stop arches 202, 204 under a shift sleeve 3′ with two detent elevations 5, 5′. The two shift sleeve sliding edges 9 facing to the inside embrace the ball pin 242 in the neutral position. The ball pin 242 is pushed away from the central axis into the slide sleeve 3′ by the ball pin spring 244. Through the introduction of a displacement force via the annular groove 7 the increased expenditure of energy for pressing over the ball pin 242 may be introduced through the shift sleeve sliding edge 9 and through the contact between shift sleeve sliding edges 9 and stop arch 202 or 204.

The slide sleeve 3′ with the slide sleeve groove 7 from FIG. 14 corresponds to the slide sleeve 3′ of FIG. 13 with the detent elevations 5, 5′ and the depression or groove located in-between. The ball pin 342 may be pressed into this groove via the ball pin spring 344 when the slide sleeve 3′ is arranged in the locking position or neutral position. Laterally the slide sleeve 3′ is limited by the stop arches 302, 304 which constitute the respective end of the spring 301, 301′.

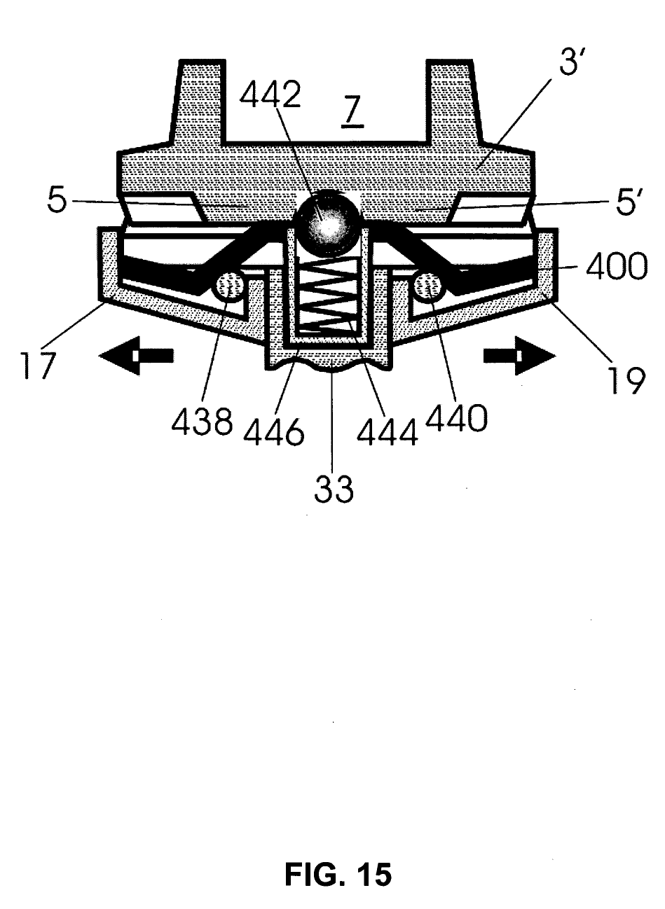

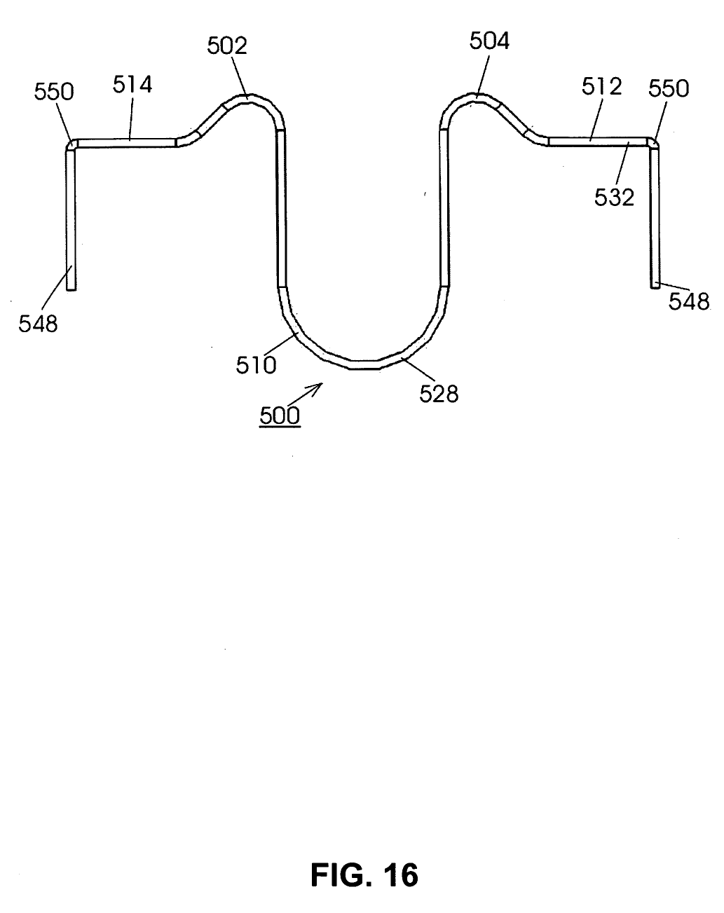

According to FIG. 15 a pressure element-like spring 400 preloaded towards the outside may be configured between the two synchronizing rings 17, 19 through the annular springs 438, 440 so that the middle region of the pressure element 400 may be constructed with a ball pin 442 which is spring pre-loaded through the ball pin spring 444. For longitudinal guidance the ball pin spring 444 lies in the spring guide 446. The force introduced via the annular groove 7 would then have to press down the ball pin 442 next to the stop arches shown in earlier figures, so that a longitudinal displacement of the slide sleeve is possible. The synchronizer 33 offers the recess so that the spring guide 446 with the ball pin spring 444 and the ball pin 442 located above may be accommodated. The slide sleeve 3′ with the annular groove 7 and the detent elevations 5, 5′ is known from comparable representations of the figures described before.

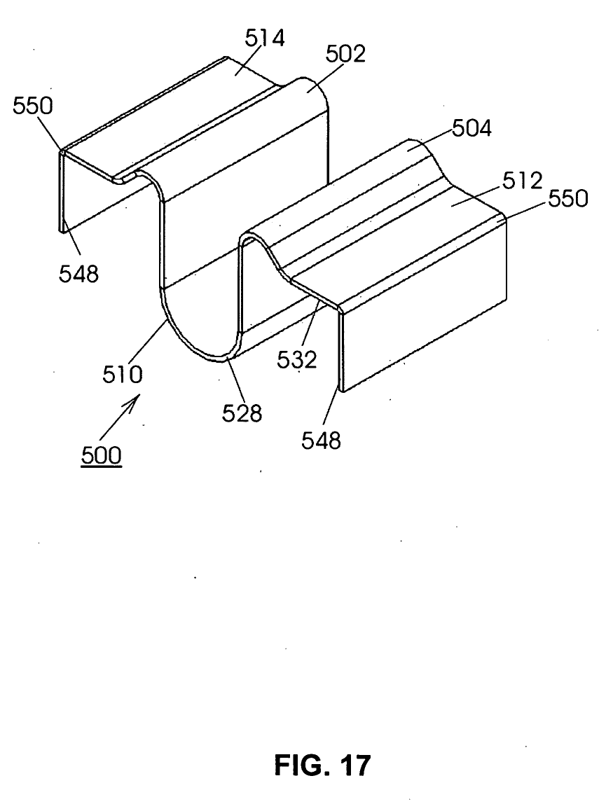

FIGS. 16 and 17 show a further embodiment of a pressure element 500 according to the invention which has been reduced to some substantial regions. Otherwise it is comparable to the representations in the FIGS. 3, 4 and 5. Sections of the simply joined pressure element 500 stand out over the central plane 532 in different directions. The pressure element 500 comprises arches facing in opposite directions, namely at least one stop arch 502, preferentially two stop arches 502, 504 and one swivel arch 528. In the design example of the FIGS. 16 and 17 the end regions 548 emerging at the end are equally oriented to the swivel arch 528 offering offsetting movements. The end regions 548 follow the support bends 550 which carry the end regions 548. A run-out region 512, 514 is associated with each stop arch 502, 504 which reaches as far as the support bends 550. A bearing of the pressure element 500 may be sought at a suitable point in the extremities of the pressure element 500, for instance in the run-out regions 512, 514, the support bends 550 or even in the end regions 548. The middle region 510 of the pressure element 500 coincides with the swivel arch 528.

The invention has been substantially presented through five different exemplary embodiments with corresponding modifications and versions. The embodiment that is to be preferred for the present transmission synchromesh case is based on the choice of the suitable force-distance diagram for each individual pressure element. For instance an exemplary embodiment is characterized by the automatic adaptation to a possible friction lining wear while another pressure element is preferred if the manufacture or the easy assembly is made a priority. Depending on the area of application, whether passenger car sector or commercial vehicle sector, the pressure element which either allows a large detent force or a preferably low detent force is to be preferred.

Now provided is a “Parts List” to help aid the reader in quickly identifying the parts as indicated by the reference numeral s shown in FIGS. 1-17. The Parts List is not to be used to limit the scope of the invention.

### PARTS LIST

### Reference Numeral

1 Transmission synchromesh unit
3, 3′ Shift sleeve, more preferably slide sleeve
5 Shift sleeve detent elevation, more preferably in the form of an insert piece.
5′ Second shift sleeve detent elevation
5″ Shift sleeve sliding groove
7 Annular groove of the shift sleeve
9 Shift sleeve sliding edge
11 First loose gear
13 Second loose gear
15 Middle of loose gears
17 First synchronizing ring
19 Second synchronizing ring
21 Coupling toothing
23 Locking toothing
25 First clutch body
27 Second clutch body
29 Axis
31 Radial direction
33 Synchronizer
35 Synchronizer outer toothing
50 Spring
100 Pressure element of the first kind
100′ Pressure element, similar to pressure element 100
102 First stop arch
104 Second stop arch
106 First clip
108 Second clip
110 Middle region
112 Right run-out region
114 Left run-out region
116 Width
118 Length
120 Height
122 Clip strap, more preferably wide clip strap
124 Clip strap, more preferably counter-formed short clip strap
126 Clip strap, more preferably counter-formed short clip strap
128 Swivel arch
130 Clip strap, more preferably vertical clip strap
132 Central plane
200 Pressure element of the second kind
200′ Pressure element of the second kind in alternative embodiment
202 First stop arch
204 Second stop arch
206 First clip
208 Second clip
210 Middle region
212 Right run-out region
214 Left run-out region
216 Width
218 Length
220 Height
222 Clip strap, more preferably wide clip strap
224 Clip strap, more preferably counter-formed, short clip strap
226 Clip strap, more preferably counter-formed, short clip strap
230 Clip strap, more preferably vertical clip strap
232 Central plane
242 Ball pin
244 Ball pin spring
246 Spring guide
300 Pressure element of third kind
300′ Pressure element of the third kind in alternative embodiment
301 Spring part, more preferably mirror image part of spring part 301′
301′ Spring part, more preferably mirror image part of spring part 301
302 First stop arch
304 Second stop arch
306 First clip
308 Second clip
310 Middle region
312 Right run-out region
314 Left run-out region
316 Width
318 Length
320 Height
322 Clip strap, more preferably wide clip strap
332 Central plane
334 First return arm
336 Second return arm
342 Ball pin
344 Ball pin spring
345 Spring guide
346 Drawing-in bevel of the first kind (lying inside)
346 Drawing-in bevel of the second kind (facing outward)
400 Pressure element of the fourth kind
402 Stop arch
410 Middle region
412 Right run-out region
414 Left run-out region
416 Width
418 Length
420 Height
432 Central plane
434 First rising bevel
436 Second rising bevel
438 First annular spring
440 Second annular spring
442 Ball pin
444 Ball pin spring
446 Spring guide
500 Pressure element, more preferably rudimentary embodiment
502 First stop arch
504 Second stop arch
510 Middle region
512 Right run-out region
514 Left run-out region
528 Swivel arch
532 Central plane
548 End region
550 Support bend
I Locking position
II Neutral position
III Initial synchronization position or initial synchronization region
IV Slide-over position
V Shifted locking position
VI Primary position

In other embodiments of the invention, a transmission synchromesh unit includes at least one loose gear, more preferably at least one of two loose gears and a leaf-like shaped spring and a shift sleeve for accomplishing the initial synchronization of the at least one loose gear, more preferably the at least one of two loose gears which offers an initial synchronization and a slide-over function, the leaf-like shaped spring has a position in which it detents the shift sleeve in a first position (detented position) and the spring in addition offers the initial synchronization function and the slide-over function for the transmission synchromesh.

Optionally, the transmission synchromesh in which the detented position is present in a neutral position in which the shift sleeve is placed removed from the one loose gear more preferably between the loose gears, preferentially in the middle, and a second detented position is present in a shifted position of the transmission synchromesh.

Optionally, the transmission synchromesh unit in which functionally the spring is a pressure element for synchronization improvement, more preferably for guaranteeing the initial synchronization between a locking toothing and a clutch toothing of the shift sleeve and a synchronizing ring within the transmission synchromesh, wherein it otherwise in the neutral position inhibits the shift sleeve from an axial displacement and more preferably offers at least one further function in addition.

In still other embodiments of the invention, the transmission synchromesh, more preferably according to a cone synchronization principle, includes at least one spring-like flat pressure element with at least one rim and at least a middle part at least one synchronizing ring, at least one shift sleeve, wherein the at least one spring-like flat pressure element is hinged via at least one rim to the synchronizing ring, more preferably via its rims in two synchronizing rings of the transmission synchromesh, and wherein the middle part of the pressure element for detent permits an axial position displacement of the shift sleeve through a radial movement, more preferably force-following evasive movement.

Optionally, the transmission synchromesh unit in which the pressure element is a spring which in its primary position can hold the shift sleeve in a detented position.

Optionally, the transmission synchromesh unit in which the detented position is present in a neutral position and a second detented position is present in a shifted locking position of the transmission synchromesh.

Optionally, the transmission synchromesh unit in which only the spring assumes the function of a pressure element so that no additional differently shaped components are present in the transmission synchromesh which assumes the pressure element functions.

Optionally, the transmission synchromesh unit in which the pressure element, which is more preferably formed of a spring steel, comprises an initial synchronization region which allows applying of at least one synchronizing ring to at least one friction surface and thus a radial twisting of the synchronizing ring for reaching the locking position and in which the pressure element can assume a slide-over position through springy flexibility of the pressure element, wherein more preferably the pressure element performs a spring movement completely over its width in radial direction of a shaft.

Optionally, the transmission synchromesh unit in which the spring-like pressure element oriented to the center axis of the shaft is preloaded in such a manner that the synchronizing rings are attracted towards each other in the transmission synchromesh so that they are mounted wobble-free.

Optionally, the transmission synchromesh unit in which the shift sleeve comprises a detent contour, more preferably a detent elevation on an inner side which preferentially has the form of an equal-sided trapezoid.

Optionally, the transmission synchromesh unit in which the spring has at least one stop arch facing away from the center axis of a shaft which performs the securing of the detented position via the detent contour in the neutral position.

Optionally, the transmission synchromesh unit in which the pressure element in each of the sliding directions of the shift sleeve offers a movement-inhibiting stop arch via detent contour in neutral position.

Optionally, the transmission synchromesh unit in which in the locking position, more preferably in the neutral position, the pressure element is self-supporting except for its synchronizing ring bearing and one, more preferably two, shift sleeve detent.

Optionally, the transmission synchromesh unit in which at least one lateral end, preferentially two opposing lateral ends of the rectangularly extended pressure element are fanned out in one piece in order to be able to accommodate therein a retaining pin of a synchronizing ring as spring bearing.

Optionally, the transmission synchromesh unit in which an annular spring in contact with the synchronizer with a tension facing away from the synchronizer to the outside, clamps the pressure element against the synchronizing ring so as to support it on the synchronizer.

Optionally, the transmission synchromesh unit in which the pressure element is a one-piece multiple-formed component.

Optionally, the transmission synchromesh unit in which the pressure element is formed of two springs embodied in mirror image, spatially offset from each other in installation position, between which preferentially the detent elevation of the shift sleeve can be accommodated in neutral position.

Optionally, the transmission synchromesh unit with a synchronizing ring synchromesh, for placing under a shift sleeve, which can assume an initial synchronization position, and comprises a slide-over region, in which the spring of the shift sleeve provides a shifted detent position and the spring of the shift sleeve provides a neutral position which spatially removed from the shifted detent position performs an detent of the shift sleeve.

Optionally, the transmission synchromesh unit in which one lateral end of the spring, preferentially the two opposing lateral ends of the spring, is fanned-out in one piece in order to be able to accommodate therein a retaining pin of a synchronizing ring as spring bearing.

In still other embodiments of the invention, a transmission synchromesh method, such as for a transmission synchromesh in accordance with the embodiments of the invention mentioned hereinabove, which is hinged to at least one synchronizing ring and acts together with a shift sleeve, with the phases neutral position, initial synchronization, synchronization, unlocking, free flying phase, meshing phase and shifting position, in which both in the neutral position and in the shifting position a local fixing of the shift sleeve through the pressure element in terms of a detent takes place.

The scope of the present invention also includes forming differentially shaped sheet metal-like pressure elements which are constructed with one or three stop arches. Equally, the pressure elements may also be hooked in through a spring-clip combination and clamped together with the synchronizing rings. By repositioning the function of the shifting rail detent directly into the synchromesh, many desired expectations are satisfied by the present invention, such as the shifting rail detent which may be omitted for example. The integration of functions of other components directly into the pressure element additionally offers a considerable savings potential in terms of parts and thus in costs, while numerous machining operations for instance are also omitted with components that have become superfluous.

What is claimed is:

1. A transmission synchromesh, comprising:
at least one loose gear rotationally movable about an axis;
at least one synchronizing ring rotationally movable about the axis;
at least one compression element coupled, at a greater radial extent from the axis, to the at least one synchronizing ring; and
a shift sleeve for selectively rotationally synchronizing the at least one loose gear with the at least one synchronizing ring during synchronization, and coupled, at a greater radial extent from the axis and axially positionable thereupon, to the at least one compression element and the at least one synchronizing ring, the shift sleeve comprises a detent for detenting with the at least one compression element.

2. The transmission synchromesh according to claim 1, wherein the compression element is a leaf-like shaped spring comprising a first detented position when detenting the at least one compression element, and comprises an initial synchronization function and a slide-over function.

3. The transmission synchromesh according to claim 2, wherein the first detented position is present in a neutral position in which the shift sleeve is positioned axially upon the leaf-like shaped spring, and further comprises a second detented position when the shift sleeve is positioned axially upon the leaf-like shaped spring in a shifted position.

4. The transmission synchromesh, comprising:
at least one spring-like flat pressure element comprising at least one clip and at least a middle part;
at least one synchronizing ring comprising at least one rim; and
at least one shift sleeve, wherein the at least one clip of the at least one spring-like flat pressure element is coupled to the at least one rim of the synchronizing ring, and wherein the middle part of the pressure element for detent permits an axial position displacement of the shift sleeve.

5. The transmission synchromesh according to claim 4, wherein the pressure element is a spring hinged to the at least one rim of the at least one synchronizing ring, and further comprises a primary position configured to axially hold the shift sleeve in a detented position.

6. The transmission synchromesh according to claim 5, wherein the detented position is present in a neutral position and a second detented position is present in a shifted locking position.

7. The transmission synchromesh according to claim 4, wherein the at least one spring-like flat pressure element unitarily comprises the function of a conventional pressure element and a conventional spring.

8. The transmission synchromesh according to claim 4, wherein the at least one spring-like flat pressure element is manufactured from spring steel, and further comprises an initial synchronization region and springy flexibility over its width and in a radial direction of a shaft.

9. The transmission synchromesh according to claim 4, wherein the at least one synchronizing ring comprising two synchronizing rings, each coupled to one of the at least one spring-like flat pressure element, wherein the at least one spring-like flat pressure element is configured and oriented with respect to a central axis of a shaft and is one of pre-compressed or pre-tensioned with the two synchronizing rings to reduce vibration or wobble.

10. The transmission synchromesh according to claim 4, wherein the at least one shift sleeve comprises a detent contour or elevation on an inner radial side for engaging the at least one spring-like flat pressure element.

11. The transmission synchromesh according to claim 10, wherein the detent contour or elevation is shaped in the form of an equal-sided trapezoid, and the at least one spring-like flat pressure element comprises at least one stop arch facing away from the center axis of a shaft configured to perform the securing of a detented position via the detent contour or elevation of the at least one shift sleeve.

12. The transmission synchromesh according to claim 4, wherein at least one spring-like flat pressure element further comprises mirrored portion in two axially sliding directions about a center axis configured with mirrored movement-inhibiting stop arches for detenting a detent contour of the at least one shift sleeve in a neutral position.

13. The transmission synchromesh according to claim 4, wherein at least one spring-like flat pressure element is substantially self-supporting with the coupling of the at least one synchronizing ring when the at least one shift sleeve in a locking position or neutral position.

14. The transmission synchromesh according to claim 4, wherein at least one lateral end of the spring-like flat pressure element are configured to accommodate a retaining pin as spring bearing.

15. The transmission synchromesh according to claim 4, further comprises an annular spring in contact with the synchronizer with a tension force facing radially away from the synchronizer to provide a clamping of the pressure element against the synchronizing ring.

16. The transmission synchromesh according to claim 4, wherein the at least one spring-like flat pressure element is a one-piece multiple-formed component.

17. The transmission synchromesh according to claim 4, wherein the at least one spring-like flat pressure element is formed of two springs embodied in mirror image, spatially offset from each other in installation position, between which preferentially a detent contour or elevation of the shift sleeve is accommodated in a neutral position.

18. The transmission synchromesh according to claim 4, wherein the at least one spring-like flat pressure element is configured for placing radially within a shift sleeve, which, as configured, provides an initial synchronization position, and a slide-over region, in which upon axial positioning of the shift sleeve relative to the pressure element provides a shifted detent position, and, upon another axial positioning, provides a neutral position which is spatially removed from the shifted detent position.

19. The transmission synchromesh according to claim 18, wherein the pressure element comprises at least one lateral end fanned-out in one piece to accommodate a retaining pin of the at least one synchronizing ring as a spring bearing.

20. A transmission synchromesh method for improved synchronization, the method comprising:
configuring at least one pressure element coupled to at least one synchronizing ring to axially engage a detent contour or profile of a shift sleeve; and
engaging in an axially direction the shift sleeve acting with the at least one pressure element to achieve any one of at least following phases: a neutral position, a initial synchronization, a synchronization, a unlocking, a free flying phase, a meshing phase and a shifting position, wherein in either the neutral position and the shifting position a local fixing of the shift sleeve through the pressure element in terms of a detent takes place.
